(19) United States
(12) Patent Application Publication
(10) Pub. No.: US 2015/0177266 A1
(43) Pub. Date: Jun. 25, 2015

(54) SENSORY HEAD WITH MULTIPLE SENSORS

(71) Applicants: Johannes Izak Boerhout, San Diego, CA (US); Jonathan David Murphy, Friday Harbor, WA (US)

(72) Inventors: Johannes Izak Boerhout, San Diego, CA (US); Jonathan David Murphy, Friday Harbor, WA (US)

(21) Appl. No.: 14/554,520

(22) Filed: Nov. 26, 2014

Related U.S. Application Data
(63) Continuation-in-part of application No. 14/136,643, filed on Dec. 20, 2013.
Application No. 14/136,643 is a continuation-in-part of application No. 14/502,142, filed on Sep. 30, 2014.
Application No. 14/502,142 is a continuation-in-part of application No. 14/525,449, filed on Oct. 28, 2014.

(51) Int. Cl. G01N 35/00

(52) U.S. Cl. CPC G01N 35/00732; G01N 2035/00821; G01N 2035/00752

(57) ABSTRACT

A sensor system, apparatus, and method. The sensor system can include a mobile unit having a power source, and a sensory head releasably coupled with the mobile unit. The sensory head is in electrical communication with the mobile unit so as to receive power from the power source and to provide a communication signal to the mobile unit. The sensory head includes at least a first sensor and a second sensor, wherein the sensors measure one or more characteristics of a test piece. The sensory head may be removed from the mobile unit and replaced with a different sensory head having at least two sensors.

### CROSS-REFERENCE TO RELATED APPLICATIONS

This application is a continuation-in-part of U.S. patent application Ser. No. 14/136,643, which was filed on Dec. 20, 2013, and of U.S. patent application Ser. No. 14/502,142, filed Sep. 30, 2014, and of U.S. patent application Ser. No. 14/525,449, filed Oct. 28, 2014. The entirety of each these priority applications is incorporated herein by reference.

### BACKGROUND

Various types of sensors are used in devices such as ultrasonic thickness gages, temperature gages, gas sensors, etc., for non-destructively measuring a characteristic of a test piece. Sensor devices are available in many different form factors, with smaller portable devices being useful where mobility is needed to transfer the sensor between different test pieces. However, the portability of these gauges is often offset by limitations in their capabilities. Such limitations include computing power, battery life, and display size. One way to address these challenges is to provide more powerful and efficient processors, higher-capacity batteries, and higher-resolution displays. However, a conservation of these resources may be beneficial, for example, from a cost standpoint. Moreover, different types of sensors may needed to take different types of measurements (e.g., temperature measurements require a temperature gauge, not a thickness gauge). Thus, users are often forced to carry several different sensors when, for example, conducting a walk-around inspection of an industrial facility.

In addition, the material from which the test piece is constructed, as well as its geometry, surface roughness, internal cracking, etc., may influence sensor calibration and/or sensor selection. Accordingly, calibration, especially when considering multiple different test pieces during a walk-around, may be cumbersome.

### SUMMARY

Embodiments of the disclosure may provide a sensory apparatus for measuring one or more characteristics of a test piece. The sensory apparatus can include a mobile unit comprising a sensory head, wherein the sensory head is detachable from the mobile unit. The sensory head can include a first sensor, a second sensor, an identification reader configured to acquire data representing an identifier from an identification tag, and a controller coupled with the first sensor and the second sensor and the identification reader. In response to the identification reader acquiring the data representing the identifier, the controller can cause the first sensor and the second sensor to measure the at least one characteristic of the test piece.

Embodiments of the disclosure may further provide a method for measuring one or more characteristics of a test piece. The method can include attaching a sensory head to a mobile unit, wherein the sensory head comprises a first sensor and a second sensor, placing the sensory head in communication with the test piece, performing one or more measurements on the test piece using the first sensor to obtain first measurement data, and performing one or more measurements on the test piece using the second sensor to obtain second measurement data. The method can further include, subsequent to performing the one or more measurements on the test piece using the first sensor and the one or more measurements using the second sensor, removing the sensory head from the mobile unit.

### BRIEF DESCRIPTION OF THE DRAWINGS

The accompanying drawings, which are incorporated in and constitute a part of this specification, illustrate an embodiment of the present teachings and together with the description, serves to explain the principles of the present teachings. In the figures:

FIG. 1A illustrates a schematic, perspective view of a sensor system, according to an embodiment.

FIG. 1B illustrates a schematic view of the sensor system, according to an embodiment.

FIG. 2 illustrates an exploded, perspective view of a sensory head, according to an embodiment.

FIG. 3 illustrates an exploded perspective view of contacts and an isolator ring of the sensory head, according to an embodiment.

FIG. 4 illustrates a perspective view of a body shell of the sensory head, according to an embodiment.

FIG. 5 illustrates a perspective view of a controller of the sensory head, according to an embodiment.

FIG. 6 illustrates an exploded, perspective view of a first sensor, a second sensor, and a hood of the sensory head, according to an embodiment.

FIG. 7 illustrates a flowchart of a method for sensing one or more characteristics of a test piece using two or more sensors.

It should be noted that some details of the figures have been simplified and are drawn to facilitate understanding of the embodiments rather than to maintain strict structural accuracy, detail, and scale.

### DETAILED DESCRIPTION

Reference will now be made in detail to embodiments of the present teachings, examples of which are illustrated in the accompanying drawing. In the drawings, like reference numerals have been used throughout to designate identical elements, where convenient. In the following description, reference is made to the accompanying drawing that forms a part thereof, and in which is shown by way of illustration a specific exemplary embodiment in which the present teachings may be practiced. The following description is, therefore, merely exemplary.

In general, embodiments of the present disclosure provide a mobile unit that is electrically and mechanically coupled with a sensory head. The sensory head provides at least a first sensor and a second sensor for measuring at least one characteristic of a test piece as well as an identification reader, such as a radio-frequency identification (RFID) tag reader, to name one example. The reader may be configured to acquire an identifier (e.g., tag number) from an identification tag (e.g., RFID tag) positioned at a predetermined location in, on, or near to a test piece. The identifier may be linked in a database to material properties, calibration information, sensor-selection information, and/or the like, which may be related to the predetermined location of the identification tag. The mobile unit, or a remote computing device (e.g., a ruggedized, hand-held computing device) in communication with the mobile unit, may access the location-specific information, which it may use to calibrate or otherwise analyze measurements taken by the sensory head.

Furthermore, the sensory head may be configured to automatically take test piece measurements in response to reading an identifier from the identification tag. The data collected by the sensory head during measurement of the test piece may be transmitted to the mobile unit and/or the remote device for displaying, processing, storage, etc., e.g., in association with the identifier.

The mobile unit may be provided with an electro-mechanical interface with the sensory head. The interface may be configured to support a connection with the two or more sensors, thereby, for example, providing a modular extensibility for the mobile unit. As such, the interface may allow a user to invest in one portable instrument with two or more sensors rather than requiring two different sensor devices, thereby decreasing costs and simplifying walk-around data collection. Additionally, the sensory head is detachable from the mobile unit such that the sensory head may be replaced with a different sensory head having two or more different types of sensors. Moreover, the mobile unit may interface with software applications that allow for a consistent user interaction and data sharing across the organizations, while receiving and analyzing input from different types of sensory heads.

One advantage of having the two or more sensors and identification reader close together (e.g., co-located in the sensory head) is that the identification tag may be mounted at the measurement location on or near the test piece, and the identification tag may be scanned to start the measurement. The sensory head may thus receive data representing the general physical location of the sensory head relative to the position of the test piece, and the logical measurement settings and alarm criteria associated with the test piece at the measurement location. It will be appreciated that these advantages and/or others may be provided in various embodiments of the present disclosure; however, these advantages should not be considered limiting or otherwise required.

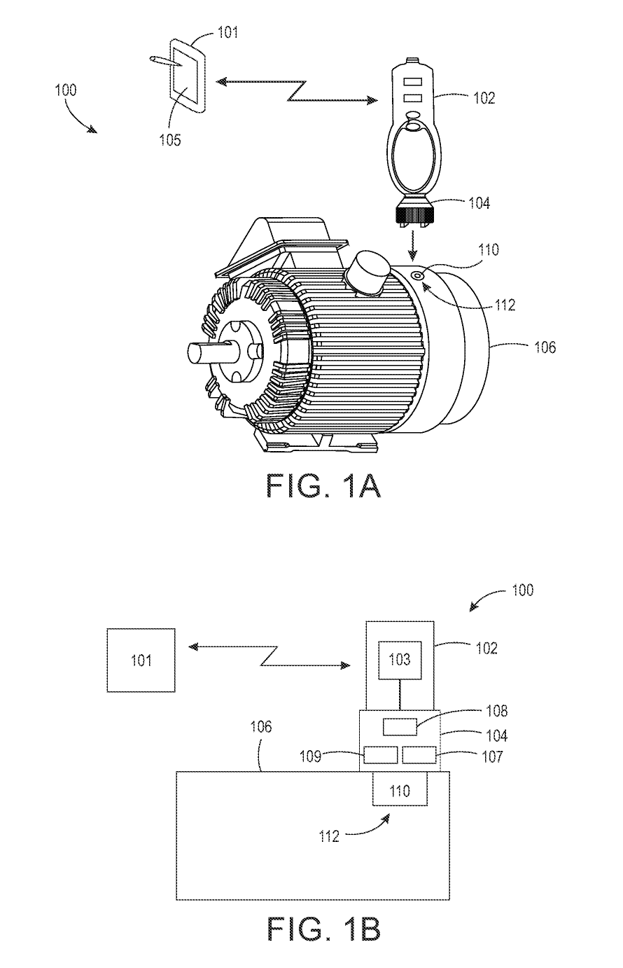

Turning now to the Figures, FIG. 1A illustrates a schematic, perspective view of a sensor system 100, according to an embodiment. FIG. 1B illustrates a simplified, schematic view of the sensor system 100, according to an embodiment. Referring to both FIGS. 1A and 1B, the sensor system 100 may include a mobile unit 102 that is in communication with a remote device 101 and in electrical and mechanical communication with a sensory head 104. The mobile unit 102 may include a power source 103, which may be a battery or a wired connection to an external power source, and may also include various other electrical and/or mechanical components.

The remote device 101 may be a portable electronic device, such as a smartphone, tablet, or laptop computer, or may be another type of specific or general-purpose computing device that is supplied with appropriate software. The mobile unit 102 may communicate with the remote device 101, and, in some embodiments, vice versa, via any suitable communications link, such as a wireless link (e.g., BLUETOOTH®, WiFi, WIMAX®, GSM, CDMA, LTE, etc.).

The sensor system 100 may also include a sensory apparatus or “head” 104 that may be releasably coupled, e.g., mechanically and electrically, with the mobile unit 102 so as to be positionally fixed thereto, receive at least power therefrom, and provide one or more signals thereto. The sensory head 104 may include, for example, at least a first sensor 107 and a second sensor 109, and may include more than the two sensors depicted. The sensors 107, 109 may be any type of sensor for measuring on or more characteristics of a test piece 106, for example vibration sensors, thickness sensors such as ultrasonic thickness sensors, temperature sensors such as thermocouples or infrared sensors, gas detection sensors, etc. The first sensor 107 may be the same or different than the second sensor 109 as described below.

In at least one embodiment, the mobile unit 102 may include a display screen 105, which may be configured to display data based on the measurements taken using the sensory head 104. In other embodiments, the display screen 105 may be omitted from the mobile unit 102, or may otherwise not display such data.

The test piece 106 may be any portion of a machine, housing, or casing thereof, for example. In at least one specific example, the test piece 106 may be a bearing housing. Accordingly, the sensor system 100, e.g. via the sensory head 104 of the mobile unit 102, may be configured to determine a characteristic of the test piece 106, which may provide information as to system integrity, health, wear indication, etc.

Further, the sensory head 104 may include an identification reader 108. The identification reader 108 may be configured to capture data representing an identifier, such as a tag number, and/or any other information from an identification tag 110 mounted in, on, or near to, or otherwise disposed proximal to, a test location 112 of the test piece 106.

In some embodiments, the identification reader 108 may be a radio-frequency identification (RFID) tag reader, and the identification tag 110 may be an active or passive RFID tag. As the term is used herein, “tag” broadly refers to any structure that may be located in, on, or near to a test piece, and should not be interpreted as requiring any particular size or shape, unless otherwise expressly stated herein. In some embodiments, the tag 110 may be a small, thin structure made of one or several layers of material, which may be adhered to the location 112. In other embodiments, the identification tag 110 may be larger, include other components (such as a processor, display screen, other input and/or output peripherals, etc.), and/or may be incorporated into a larger device. In some embodiments, the identification tag 110 may display a quick response (QR®) code, whether statically (e.g., printed) or dynamically (e.g., displayed on a display screen). In another embodiment, the identification tag 110 may display a bar code, or may provide an identifier to the identification reader 108 through any other medium, such as sound, light (e.g., infrared) pulses, etc. The identification reader 108 may be suitably configured to read the QR code, bar code, or any other identifier transmission medium selected.

The identifier read from the identification tag 110 may be associated with location-specific information, e.g., in a table or database. The database may be stored on the mobile unit 102, on the remote device 101, or on another device communicably coupled with the mobile unit 102 and/or the remote device 101. For example, the location-specific information may include the material composition, surface roughness, geometry, or any other property of the test piece 106 that may assist in selecting a sensor, calibrating the sensor, and/or analyzing the measurement data. In an embodiment, the location-specific information may additionally or instead represent historical thickness measurements at the test location 112. Such historical measurements may facilitate the calculation of measured thickness trends, which may contribute to life-cycle analysis, wear-rate determinations, system health, etc.

The sensory head 104 may be a modular unit, which may be removable from the mobile unit 102. Accordingly, when a different sensory head is needed, the sensory head 104 may be removed from the mobile unit 102, which also removes the first sensor 107 and the second sensor 109, and another sensory head attached. This may facilitate switching between different types of sensors while testing various equipment in an industrial facility.

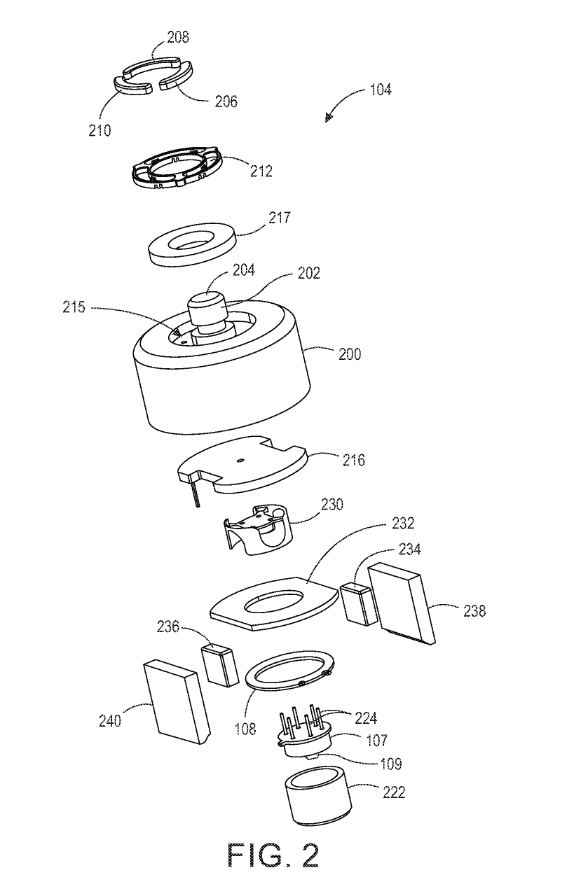

FIG. 2 illustrates an exploded view of the sensory head 104, according to an embodiment. It will be appreciated that the sensory head 104 displayed in FIG. 2 is but one specific example among many contemplated. As shown, the sensory head 104 includes a body shell 200, which may provide a rugged exterior for the sensory head 104. The sensory head 104 may also include a mounting device 202, such as a threaded stud, “quick-release” shaft, threaded opening, quick-release shaft collar, tabs, magnet, or any other device for mounting the sensory head 104 to the mobile unit 102. Accordingly, the mobile unit 102 (e.g., FIG. 1) may include a receptacle, such as a female threaded connection, quick connect shaft or collar, magnet, etc., for receiving and coupling with the mounting device 202.

The sensory head 104 may also include a ground connection 204, which may be integrated into the mounting device 202. The ground connection 204 may be electrically connected with the mobile unit 102. Accordingly, using the mounting device 202, the sensory head 104 may be placed into electro-mechanical communication with the mobile unit 102 and/or quickly removed from such communication therewith.

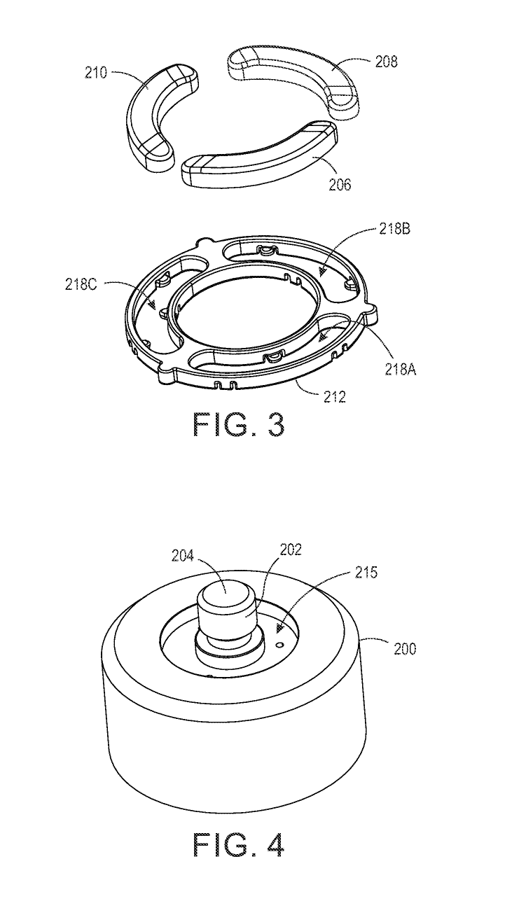

Several elements of the sensory head 104 embodiment depicted in FIG. 2 will now be described with reference to enlarged views thereof provided in FIGS. 3-6. Reference is thus made to each of FIGS. 3-6 individually, with continuing reference to the context provided by the illustrated embodiment of FIG. 2.

The sensory head 104 may include at least one contact (three are shown: 206, 208, 210) and an isolator ring 212. FIG. 3 illustrates an enlarged, perspective view of the contacts 206-210 and the isolator ring 212, according to an embodiment. As shown, the contacts 206-210 may be formed as arc-shaped members. The isolator ring 212 may include slots 218A, 218B, 218C, which may receive the contacts 206-210, respectively. The isolator ring 212 may thus serve to electrically isolate the contacts 206-210 from one another.

In an embodiment, the contact 206 may be configured to deliver power from the mobile unit 102 to the sensory head 104. The contact 208 may be configured to deliver a digital input signal from the mobile unit 102 to the sensory head 104. The contact 210 may be configured to deliver a digital output signal to the mobile unit 102, e.g., based on a signal from the sensory head 104. Although not depicted, in another embodiment, a fourth contact may be provided and seated within a slot of the isolator ring 212, for providing a communication signal from an identification reader (e.g., antenna) to the mobile unit 102, as will be described below.

FIG. 4 illustrates an enlarged, perspective view of the body shell 200, according to an embodiment. As mentioned above, the body shell 200 may include the mounting device 202 and the ground connection 204. The body shell 200 may also include a recess 215, which may be defined at least partially around the mounting device 202. The contacts 206-210 and the isolator ring 212 may seat in the recess 214; however, in other embodiments, the contacts 206-210 and body shell 200 may be coupled together, or otherwise positioned, in any other manner. Further, the contacts 206-210 and isolator ring 212 may be disposed in or “potted” in a resin 217, or another material, which may provide a stable and, for example, electrically insulating mount for the contacts 206-210 and isolator ring 212 in the recess 215.

The sensory head 104 may further include the first sensor 107, the second sensor 109, and a hood 222. The hood 222 may cover at least a portion of the sensors 107, 109, thereby shielding them from the surrounding environment. FIG. 6 illustrates an enlarged, exploded, perspective view of the sensors 107, 109 and the hood 222, according to an embodiment. While FIG. 6 depicts one particular form factor including the first sensor 107 and the second sensor 109, it will be appreciated that other form factors for two or more sensors are contemplated depending on the design and/or use of the sensory head 104.

As shown, the first sensor 107 and the second sensor 109 may be physically coupled with at least one of a plurality of leads 224. For example, the sensors 107, 109 may receive power and/or one or more digital communication signals via the leads 224 and provide a digital signal via another one of the leads 224. The leads 224 may, in turn, be electrically connected with a controller 216 and/or the contacts 206-210, and eventually with the mobile unit 102 (FIG. 1). While six pin-style electrical leads 224 are depicted, it will be appreciated that any number and any style of leads 224 may be used, depending on the design and intended use of the mobile unit 102 (FIG. 1A) and sensory head 104. A first portion of the leads 224 provides input to, and/or output from, the first sensor 107, while a second portion of the leads 224 provides input to, and/or output from, the second sensor 109. More than two sensors within the same sensory head 104 (FIG. 1) are contemplated. In an embodiment, two sensors may measure the same test piece characteristic wile a third sensor measures a different test piece characteristic.

In an embodiment, the first sensor 107 may be, for example, an ultrasonic thickness sensor and the second sensor 109 may be an infrared temperature sensor. Various other sensors that measure other characteristics of a test piece 106 (FIG. 1) in addition to temperature sensors and thickness sensors are contemplated, for example, including (but not limited to) a vibration sensor, a gas detection sensor, a voltage sensor, a pressure sensor, a humidity sensor, etc. As discussed above, the first sensor 107 and the second sensor 109 may be different and measure different characteristics of the test piece. In another embodiment, the first sensor 107 and the second sensor 109 may be identical and thus measure the same aspect of the characteristic of the test piece to provide measurement redundancy. In another embodiment, the first sensor 107 and the second sensor 109 may be different and measure the same characteristic but different aspects of the characteristic, for example by using different measurement techniques and/or by measuring the characteristic over, for example, different ranges of the same characteristic of the test piece. For example, the first sensor 107 may measure a first range of vibrational amplitudes and/or frequencies while the second sensor 109 may measure a second range of vibrational amplitudes and/or frequencies, where the second range is different from the first range. In another example, the first sensor 107 may measure temperature of the test piece using a thermocouple while the second sensor 109 may measure temperature of the test piece using an infrared sensor. Using two different types of sensors to measure the same characteristic with different measurement techniques may provide measurement redundancy as well as increased accuracy through the use of two different measurement techniques.

In an embodiment, the two or more sensors may operate and perform measurements on a test piece sequentially (i.e., serially), for example if the operation of one sensor would affect the accuracy of the reading of another sensor. Sequential readings from the two or more sensors may also be employed, for example, if temporally spaced test piece operational modes are being tested. In another embodiment, the two or more sensors may operate and perform measurements on a test piece with some overlap or even simultaneously, particularly where operation of one sensor does not affect the accuracy of the reading of the other sensor. Simultaneous or overlapping measurements from two sensors may, in some cases, decrease measurement time and maintain a level of phase correlation between the two measurements from the two or more sensors that may be helpful in establishing a diagnosis for a malfunctioning test piece.

In an embodiment, the two or more sensors can measure two different characteristics of a test piece, such as two or more of vibration, thickness, temperature, etc. In another embodiment, where increased measurement accuracy or reliability is desired, the two or more sensors can measure the same characteristic of the test piece, for example to provide high reliability through sensor redundancy. Sensory heads with identical sensors or sensors with similar functionality that measure the same test piece characteristic may be used to provide high measurement reliability through redundancy, for example in applications where failures are not easily tolerated. Further, measurement values of identical sensors may be used in a scheme to boost accuracy or calibrationless sensing. Similarly, sensory heads populated with a plurality of sensors that are similar (i.e. all temperature, or all vibration, or all pressure, etc.) can be used to provide extended, wide data range measurement.

In one specific example, vibration sensors may be classified in different vibration ranges. For example, a more sensitive vibration sensor may be required in environments to measure low level (low amplitude) vibrations, while a less sensitive vibration sensor may be used environments to measure high level (high amplitude) vibrations. Thus a sensory head in accordance with an embodiment may include both a low-range sensor providing a low-range output and a high-range sensor providing a high-range output. Outputs from these two sensors can be processed using combinatory logic and/or analog amplification to blend the outputs into a single measurement value output to provide a combined output that reflects data points across a wide range of vibrational amplitudes and a high sensitivity. Signal processing of the outputs from the sensor can be performed using, for example, circuitry in the controller 216 and/or circuitry in the remote device 101.

Referring now again specifically to FIG. 2, the sensory head 104 may also include an identification reader 108. The identification reader 108 may be configured to detect an identifier from the identification tag 110 (FIG. 1), as noted above. Accordingly, in an RFID embodiment, the identification reader 108 may be an RFID antenna (e.g., an active or passive RFID reader), and may include a tuned, wire loop, which may receive a modulated radio frequency signal from the RFID tag. The received radio frequency signal may provide data representing the identifier associated with the RFID tag. In active-reader embodiments, the identification reader 108 may also transmit a signal to the RFID tag, providing the energy for the signal carrying the identifier. In other embodiments, the identification reader 108 may be an optical sensor, which may read a QR code or a bar code provided by the identification tag 110, or may be any other type of sensor configured to receive information from the identification tag 110. In an embodiment, at least one of the contacts 206-210 may transmit the read tag information through a digital output signal, and out of the sensory head 104 into the mobile unit 102.

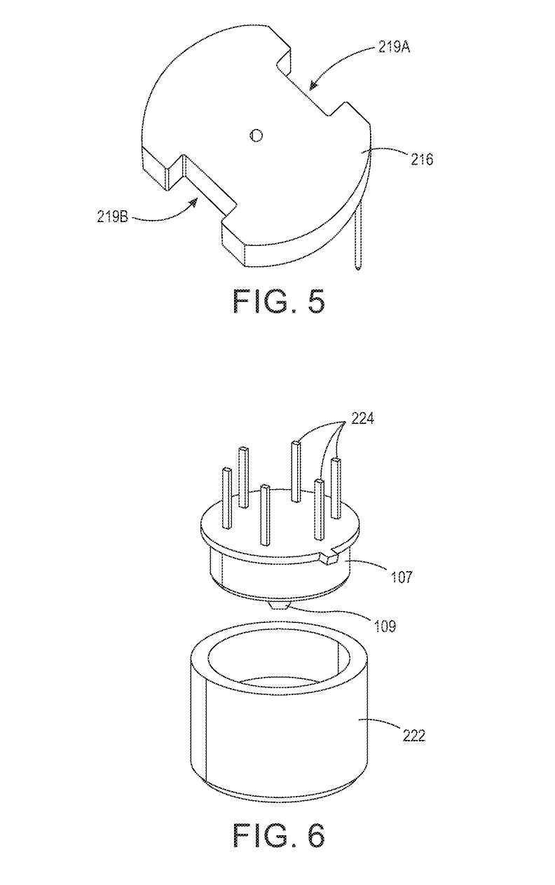

The controller 216, coupled with the leads 224 as noted above, may control operation of, including the power supply to, the sensory head 104, among other functions. FIG. 5 illustrates an enlarged view of the controller 216, according to an embodiment. The controller 216 may be or include one or more printed circuit boards (PCBs). In at least some embodiments, the controller 216 may include one or more microprocessors, electrical contacts/leads, electrical pathways, etc. The controller 216 may be in electrical communication with one or more of the contacts 206-210, as well as the ground connection 204.

Further, the controller 216 may define one or more magnet slots 219A, 219B, which may be formed as cut-outs extending inwards from the periphery of the controller 216. The controller 216 may be configured to selectively power the various elements of the sensory head 104, receive information therefrom, transmit information to the mobile unit 102, and/or otherwise control a functioning of the sensory head 104.

The sensory head 104 may also include a support assembly for the identification reader 108. For example, the support assembly may include a reader spacer 230 around which the identification reader 108 (e.g., a loop-shaped antenna) may be received, and a reader plate 232, which may couple with the identification reader 108 and the controller 216, so as to position the identification reader 108 with respect thereto. In some embodiments, however, the identification reader 108 may be or include an RFID spiral antenna or a wound inductor antenna, which may be coupled with the reader plate 232.

The sensory head 104 may also include one or more mounting feet (two are shown: 238, 240). The mounting feet 238, 240 may be fabricated at least partially of a highly-permeable material, which may transmit the magnetic flux generated by magnets 234, 236. Further, the mounting feet 238, 240 may, in at least some embodiments, extend beyond the hood 222 so as to physically contact the test piece 106. In other embodiments, the mounting feet 238, 240 may not extend past the hood 222 and may, instead, be housed therein, transmitting the magnetic flux therethrough. Moreover, it will be appreciated that the magnets 234, 236 and/or mounting feet 238, 240 may be provided in any suitable shape and configuration, with the illustrated embodiment being merely one among many contemplated. Furthermore, in some embodiments, the magnets 234, 236 may be configured to bear directly on the test piece 106, with the mounting feet 238, 240 being omitted. In still other embodiments, the magnets 234, 236 and the mounting feet 238, 240 may be unnecessary and omitted.

Referring again to FIGS. 1 and 2, in an example of operation, the mobile unit 102 may be brought into proximity of the identification tag 110 (e.g., RFID tag). The identification reader 108 may read an identifier from the identification tag 110. For example, the identification reader 108 may poll for identification tags to read, e.g., by sending a signal constantly or intermittently. A preliminary trigger may also be provided to initiate such polling, such as a signal from the remote device 101, the controller 216 detecting the magnets 234, 236 engaging the test piece 106, or another trigger. In other embodiments, the identification reader 108 may be energized manually via user input to seek an identification tag 110 to read (e.g., to begin transmitting an energizing radio-frequency signal). In still other embodiments, the identification reader 108 may automatically detect proximity to an identification tag 110 in any other way.

The controller 216 may detect when the identification reader 108 reads a signal from the identification tag 110. In response, the controller 216 may cause the sensors 107, 109 to begin the measurement process appropriate for the type of sensor. In a specific embodiment, the controller 216 may provide power to the first sensor 107 and the second sensor 109 and receive data therefrom, e.g., via the leads 224. In some embodiments, the controller 216 may be operable independently to cause the sensors 107, 109 to commence measuring. In other embodiments, the controller 216 may interface with a separate controller housed in the mobile unit 102, the remote device 101, or elsewhere, for initiation of the measuring of the characteristic.

In some embodiments, in addition to or instead of initiating measurement when the identification reader 108 reads an identifier, the controller 216 may be configured to detect when the magnets 234, 236 magnetically engage the test piece 106, e.g., via the mounting feet 238, 240. In some embodiments, the controller 216 (or another part of the mobile unit 102 and/or remote device 101) may be responsive to a user input, e.g., a user pressing a button on the mobile unit 102 and/or remote device 101, and may initiate thickness measurements in response to such manual input.

When the identification reader 108 obtains an identifier from the identification tag 110, the sensory head 104 (e.g., the controller 216) may provide a signal to the mobile unit 102 that includes a digital representation of the identifier. The mobile unit 102 may, in some embodiments, relay the identifier to the remote device 101. In some embodiments, the remote device 101 and/or the mobile unit 102 may query a database, using the obtained identifier, so as to determine the location-specific information associated with the test location 112 of the test piece 106. The mobile unit 102 and/or the remote device 101 may then use this information to assist in calibration of sensor data, and/or analysis thereof.

Furthermore, the recorded measurement(s) from the sensors 107, 109 may be stored in association with the identifier. The identifier, which may be linked to a machine and/or the specific location 110, may thus provide an index to a history of measurements, which may be updated each time the thickness of the test piece 106 is measured in response to a particular identifier being read.

In an embodiment, the physical connection and/or the electrical connection between the mobile unit and the sensory head may be releasable without damaging either. For example, multiple sensory heads, e.g., with multiple different types and/or sizes of sensors may be provided as modular units.

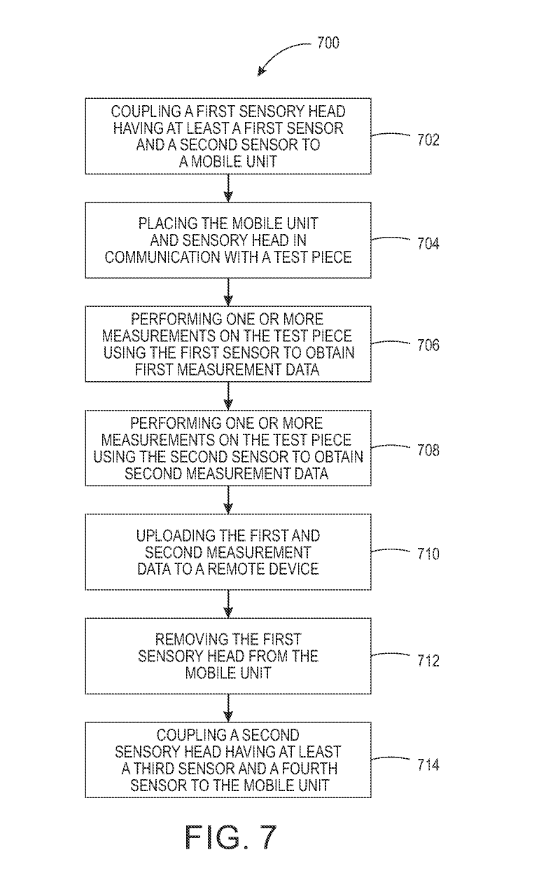

FIG. 7 is a flow chart depicting an embodiment using a sensory head having at least a first sensor and a second sensor. The first sensor and the second sensor may be the same or different from each other. At 702, a sensory head having at least a first sensor and a second sensor is coupled to a mobile unit. The sensory head may be coupled using one or more of a physical connection, an electrical attachment, an optical attachment, or using a wired or wireless connection. At 704, the mobile unit and sensory head are placed in communication with a test piece. The communication may include a physical attachment, an electrical attachment, an optical attachment, or using a wired or wireless connection to attach the sensory head to the test piece.

Subsequently, one or more measurements are performed on the test piece using the first sensor to obtain first measurement data as shown at 706. At 708, one or more measurements are performed on the test piece using the second sensor to obtain second measurement data. The processing described at 708 may be after or during the processing described at 706. At 710, the first measurement data and the second measurement data are uploaded to a remote device. The uploading may occur at a different time, such as after the processing stage described at 712, where the first sensory head is removed from the mobile unit. Optionally, after removal of the first sensory head, a second sensory head having at least a third sensor and a fourth sensor may coupled to the mobile unit. The third sensor and the fourth sensory may be the same or different from each other, and the same or different from the first sensor and the second sensor.

While the present teachings have been illustrated with respect to one or more implementations, alterations and/or modifications may be made to the illustrated examples without departing from the spirit and scope of the appended claims. It will be appreciated that while the process is described as a series of acts or events, the embodiments are not limited by the ordering of such acts or events. Some acts may occur in different orders and/or concurrently with other acts or events apart from those described herein. Also, not all process stages may be required to implement a methodology in accordance with one or more aspects or embodiments of the present teachings, and additional processing stages may be incorporated. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A sensory apparatus for measuring one or more characteristics of a test piece, the sensory apparatus comprising:
a mobile unit; and
a sensory head electrically and mechanically coupled with the mobile unit, wherein the sensory head comprises:
a first sensor;
a second sensor;
an identification reader configured to acquire data representing an identifier from an identification tag; and
a controller coupled with the first sensor and the second sensor and the identification reader, wherein, in response to the identification reader acquiring the data representing the identifier, the controller causes the first sensor and the second sensor to measure the at least one characteristic of the test piece.

2. The apparatus of claim 1, wherein:
the first sensor is configured to measure a first characteristic of the test piece; and
the second sensor is also configured to measure the first characteristic of the test piece.

3. The apparatus of claim 2, wherein:
the first sensor is configured to measure a first aspect of the first characteristic; and
the second sensor is configured to measure a second aspect of the first characteristic, where the second aspect is different from the first aspect.

4. The apparatus of claim 1, wherein:
the first sensor is configured to measure a first characteristic of the test piece; and
the second sensor is configured to measure a second characteristic of the test piece, wherein the first characteristic is different from the second characteristic.

5. The apparatus of claim 1, wherein the identification reader comprises a radio-frequency identification (RFID) antenna.

6. The apparatus of claim 1, wherein the identification reader comprises a bar-code scanner, a quick response code scanner, or a combination thereof.

7. The apparatus of claim 1, wherein the sensory head further comprising a body shell into which the identification reader and the controller are at least partially received, the body shell comprising a mounting device configured to be removably coupled with a mobile unit.

8. The apparatus of claim 7, wherein the body shell defines a recess therein, the apparatus further comprising one or more electrical contacts received into the recess and electrically coupled with the controller, the one or more electrical contacts being configured to electrically communicate with the mobile unit, when the mounting device is coupled therewith.

9. The apparatus of claim 8, wherein the recess extends at least partially around the mounting device.

10. The apparatus of claim 1, further comprising one or more magnets, the one or more magnets being configured to mechanically engage the test piece.

11. The apparatus of claim 10, wherein the controller is configured to detect when the one or more magnets magnetically engage the test piece.

12. A method for measuring one or more characteristics of a test piece, comprising:
attaching a sensory head to a mobile unit, wherein the sensory head comprises a first sensor and a second sensor;
placing the sensory head in communication with the test piece;
performing one or more measurements on the test piece using the first sensor to obtain first measurement data;
performing one or more measurements on the test piece using the second sensor to obtain second measurement data; and
subsequent to performing the one or more measurements on the test piece using the first sensor and the one or more measurements using the second sensor, removing the sensory head from the mobile unit.

13. The method of claim 12, where the sensory head is a first sensory head, and the method further comprises attaching a second sensory head to the mobile unit, wherein the second sensory head comprises a third sensor and a fourth sensor that are different from the first sensor and the second sensor.

14. The method of claim 12, further comprising:
measuring a first characteristic of the test piece using the first sensor; and
measuring the first characteristic of the test piece using the second sensor.

15. The method of claim 14, wherein further comprising:
measuring a first aspect of the characteristic using the first sensor; and
measuring a second aspect of the characteristic using the second sensor, wherein the first aspect of the characteristic is different than the second aspect of the characteristic.

16. The method of claim 12, further comprising:
measuring a first characteristic of the test piece using the first sensor; and
measuring a second characteristic of the test piece using the second sensor, wherein the first characteristic is different than the second characteristic.

17. The method of claim 12, further comprising:
transmitting an identifier from the test piece to an identification reader within the mobile unit; and
in response to the identification reader acquiring the identifier, initiating the performing of the one or more measurements on the test piece using the first sensor to obtain the first measurement.

18. The method of claim 17, further comprising acquiring the identifier using a radiofrequency identification (RFID) antenna within the sensory head.

19. The method of claim 17, further comprising acquiring the identifier using a bar-code scanner, a quick response code scanner, or a combination thereof.

20. The method of claim 12, further comprising uploading the first measurement data and the second measurement data from the mobile unit to a remote device.
